(19) United States
(12) Patent Application Publication
(10) Pub. No.: US 2015/0228986 A1
(43) Pub. Date: Aug. 13, 2015

(54) LIQUID-ACTIVATED HYDROGEL BATTERY

(71) Applicants: James Y. WANG, Beijing (CN); EMPIRE TECHNOLOGY DEVELOPMENT LLC, Wilmington, DE (US)

(72) Inventor: James Y. Wang, Beijing (CN)

(21) Appl. No.: 14/426,661

(22) PCT Filed: Nov. 7, 2012
(86) PCT No.: PCT/CN2012/084223

§ 371 Date: Mar. 6, 2015

(51) Int. Cl. H01M 6/32; H01M 4/06; H01M 6/02

(52) U.S. Cl. CPC H01M 6/32; H01M 6/02; H01M 4/06; H01M 2004/027

(57) ABSTRACT

Liquid-activated batteries and associated methods are disclosed. A liquid-activated battery may comprise a hydrogel permeated with electrolyte and an anode and a cathode in contact with the hydrogel. The hydrogel may become hydrated responsive to contact with a liquid. The hydrated hydrogel may support ionic communication between the anode and the cathode via the electrolyte. The liquid-activated battery may generate a voltage to power an electronic device due to the ionic communication. The hydrogel may be dehydrated such that ionic communication does not occur between the anode and the cathode.

### BACKGROUND

Consumer and industrial applications for battery-powered electronic devices continue to increase dramatically. One area of attention involves electronic devices developed for use in wet or substantially wet environments, including devices that go between wet and dry environments that require activation in the wet or substantially wet environment. Traditionally, battery power sources area sealed in “water-proof” containers when used in wet environments. In addition to adding bulk and weight, these cases require additional maintenance, make for difficult or complicated battery changes, and are prone to water leaks that may damage the power source or the internal electronics of the device. Even if the device does not leak, the act of opening the container to change a battery exposes it to be potentially wet surrounds, or at least to water on the surface of the container.

### SUMMARY

This disclosure is not limited to the particular systems, devices and methods described, as these may vary. The terminology used in the description is for the purpose of describing the particular versions or embodiments only, and is not intended to limit the scope.

In an embodiment, a liquid-activated battery may comprise at least one hydrogel in association with at least one hydrophilic polymer and at least one electrolyte. The at least one hydrogel may be configured to recurrently alternate between a hydrate state responsive to contact with liquid and a dehydrated state responsive to an effective absence of liquid. The liquid-activated battery may further comprise at least one anode and at least one cathode in contact with the at least one hydrogel. Ionic communication may occur between the at least one anode and the at least one cathode via the at least one electrolyte, supported by the at least one hydrogel in the hydrated state and not supported by the at least one hydrogel in the dehydrated state. The ionic communication may operate to generate an electric current for the battery.

In another embodiment, an electronic device may compose a power supply having a liquid-activated battery. The liquid-activated battery may comprise at least one hydrogel containing at least one hydrophilic polymer and at least one electrolyte. The at least one hydrogel may be configured to recurrently alternate between a hydrated state responsive to contact with liquid and a dehydrated state responsive to an effective absence of liquid. The liquid-activated battery may further comprise at least one anode and at least one cathode in contact with the at least one hydrogel. Ionic communication may occur between the at least one anode and the at least one cathode via the at least one electrolyte, supported by the at least one hydrogel in the hydrated state and not supported by the at least one hydrogel in the dehydrated state. The ionic communication may operate to generate an electric current for the battery.

In an additional embodiment, a method of preparing a liquid-activated battery comprises providing at least one hydrogel consisting of at least one hydrophilic polymer and at least one electrolyte. The at least one hydrogel may be configured to recurrently alternate between a hydrated state responsive to contact with liquid and a dehydrated state responsive to an effective absence of liquid. The method may further comprise arranging at least one anode and at least one cathode to be in contact wish the at least one hydrogel. Ionic communication between the at least one anode and the at least one cathode via the at least one electrolyte may be supported by the at least one hydrogel in the hydrated state and may not be supported by the at least one hydrogel in the dehydrated state. The ionic communication may operate to generate an electric current for the battery.

In a further embodiment a method of providing battery power to as electronic device using a liquid-activated battery may comprise connecting the liquid-activated battery as a power scarce to the electronic device. The liquid-activated battery comprises at least one hydrogel consisting of at least one hydrophilic polymer and at least one electrolyte. The at least one hydrogel may he configured to recurrently alternate between a hydrated state responsive to contact with liquid and a dehydrated state responsive to art effective absence of liquid. The liquid-activated battery may further comprise at least one anode and at least one cathode in contact with the at least one hydrogel. Ionic communication between the at least one anode and the at least one cathode via the at least one electrolyte may be supported by the at least one hydrogel In the hydrated state and may not be supposed by the at least one hydrogel in the dehydrated state. The ionic communication may operate to generate an electric current for the battery. The method may further comprise exposing the liquid-activated battery to liquid such that the liquid contacts the at least one hydrogel The at least one hydrogel may eater the hydrated state responsive to contacting the liquid and the liquid-activated battery may generate a voltage that powers the electronic device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 depicts a block diagram of art illustrative liquid-activated batten according to an embodiment.

FIG. 2A depicts a block-diagram of an illustrative liquid-activated batten comprising a hydrogel in a hydrated state according to an embodiment.

FIG. 2B depicts a block-diagram of as illustrative liquid-activated battery comprising a hydrogel in a dehydrated state according to an embodiment.

FIG. 3 depicts a flow diagram for an illustrative method of manufacturing a liquid-activated battery according to an embodiment.

FIG. 4 depicts a flow diagram for an illustrative method of providing battery power to an electronic device according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

The following terms shall have, for the purposes of this application, the respective meanings set forth below.

“Hydrogel” refers to a gel-like formed by a class of polymer materials that can absorb liquid without dissolving. Hydrogels generally comprise a network of cross-linked hydrophilic polymers, which, in general, are polymers containing polar or charged functional groups that make them soluble in water. Illustrative hydrophilic polymers include polymethacrylate, polyacrylate, polymethacrylamide, polyacrylamide, polyvinyl alcohol, polyvinyl acetate, cellulose or modified cellulose, collagen or modified collagen, polysaccharide, modified polysaccharide, polynucleotide, polyhydroxyethyl methacrylate (pHEMA), polyelectrolyte, or combinations thereof. Certain hydrogels may incorporate other solid or liquid material, such as antimicrobial medicines, vitamins, and electrolytes.

The present disclosure is directed to a liquid-activated battery. The liquid-activated battery comprises a hydrogel-forming hydrophilic polymer permeated with an electrolyte. An anode and a cathode are arranged in contact with the hydrogel to complete a power circuit. When the hydrogel-forming polymer is hydrated, ionic communication occurs between the anode and the cathode via the electrolyte within the hydrated hydrogel. The hydrogel is hydrated when it is in contact with an effective amount of liquid, for example, water. This may correspond to partial or complete hydration of the hydrogel, depending upon characteristics of the hydrogel. Conversely, the hydrogel is dehydrated when there is an effective absence of liquid.

“Liquid-activated” refers to an element or system being active responsive to exposure to a liquid. For example, a water-activated battery operates to generate a current responsive to exposure to water and is inactive when it is not exposed to water. In general, a liquid-activated system will require an effective amount of the liquid to operate, wherein an effective amount is the amount required to activate the system and to maintain functionality. Alternatively, a liquid-activated system will be inactive responsive to an effective absence of the liquid, wherein an effective absence is the amount of the liquid below which the system will not operate. For clarity, the activation may be due to a single exposure or through repeated or continuous exposure. It is also contemplated that hydration in some embodiments may be achieved through exposure to water vapor alone or in combination with liquid water.

“Hydrated” as used herein with reference to a hydrogel, refers to a state wherein the hydrogel contains a liquid, such as water, in an effective amount for allowing ionic communication to occur between an anode and a cathode in contact with the hydrogel. A hydrogel is in a hydrated state when it contains an effective amount of water or other liquid, and such an effective amount may result in either partial or complete hydration. An effective amount of liquid is dependent upon certain factors, such as the composition and/or function of the hydrogel. Hydration may occur acutely or over time in response to contact with liquid or vapor forms. In the alternative, an effective absence of liquid occurs when there is not enough liquid in the hydrogel for ionic communication between the anode and the cathode.

“Dehydrated” as used herein with reference to a hydrogel refers to a state where the there is an effective absence of liquid, such as water, in the hydrogel, such that ionic communication does not occur between an anode and a cathode in contact with the hydrogel. An effective absence of liquid is dependent upon certain factors, such as the composition and/or function of the hydrogel and may be a partial absence of liquid or a complete absence of liquid.

“Ionic communication” refers to the transfer of ions between two or mere elements. For example, is a battery, ionic communication comprises the transmission of ions between anode and cathode electrodes within an electrolyte. Ionic communication between the anode and the cathode operates to generate a voltage when the power circuit of the liquid-activated battery is closed, for example, when the liquid-activated battery is connected to an electronic device. In this manner, the liquid-activated battery may operate to provide a voltage to power an electronic device when the hydrogel is hydrated.

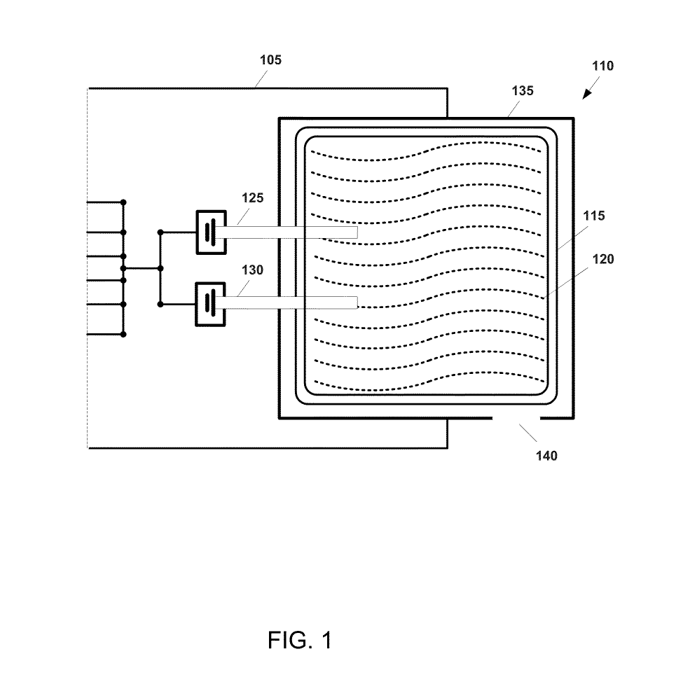

FIG. 1 depicts a block diagram of an example liquid-activated battery configured according to an embodiment. As shown in FIG. 1, the liquid-activated battery 110 may comprise a battery case 135 enclosing a hydrogel 115 permeated with an electrolyte 120. The electrolyte 120 is depicted as a series of dashed lines for illustrative purposes only. Those of skill in the art will recognize that the electrolyte will likely not be arranged in uniform rows as depicted. A cathode 125 and an anode 130 may be in contact with the hydrogel 115 and with the electrolyte 120 contained within the hydrogel 115. The battery case 135 may have one or more openings 140 to allow liquid to enter and exit the battery 110. For example, the battery case 135 may be made of a porous material or a water permeable material. In some embodiments, the battery case 135 comprises a water permeable membrane. Thus, the battery case 135 needs not be a bulky physical structure, but may comprise a thin flexible water permeable membrane allowing water to pass in and out of the hydrogel. The liquid may enter the battery 110 and saturate (e.g., hydrate) the hydrogel and, therefore, the electrolyte 120. When the hydrogel is effectively hydrated with the liquid, the hydrogel is in a state that supports a flow of ions between the anode 130 and cathode 125 via the electrolyte 120. The flow of ions between the anode 130 and the cathode 125 may operate to generate a voltage for the liquid-activated battery 110. A battery-powered electronic device 105 may use the liquid-activated battery 110, either in whole or in part, as a power supply. The liquid-activated battery 110 may power some or the entire electronic device 105 with the voltage generated due to the flow of ions between the anode 130 and the cathode 125.

According to some embodiments, the hydrogel 115 may consist of one or more hydrophilic polymers, including, without limitation, polymethacrylate, polyacrylate, polymethacrylamide, polyacrylamide, polyvinyl alcohol, polyvinyl acetate, cellulose or modified cellulose, collagen or modified collagen, polysaccharide, modified polysaccharide, polynucleotide, polyhydroxyethyl methacrylate (pHEMA), polyelectrolyte, and combinations thereof.

Some embodiments provide that the anode 130 may consist of an anode material comprising zinc, magnesium, aluminum, calcium, lithium, conducting polymers, iron, nickel, metal oxides, or combinations thereof. The cathode 125 may be configured according to some embodiments to consist of a cathode material comprising one or more of copper, carbon, silver, metal oxides, conducting polymers, carbon, carbon nanotubes, graphite, graphene, and combinations thereof.

The electrolyte 120 may consist of certain classes of materials depending on various factors, such as the type of hydrogel, anode material, cathode material, operating environment, and expected liquid saturation levels. Classes of materials that may be used for the electrolyte include, without limitation, salts, acids, and bases.

According to some embodiments, the electrolyte 120 may include a salt comprising ammonium sulfate, ammonium hydrogen sulfate, ammonium nitrate, ammonium phosphate, ammonium hydrogen phosphate, ammonium dihydrogen phosphate, ammonium chloride, sodium hydrogen sulfate, potassium hydrogen sulfate, sodium dihydrogen phosphate, potassium dihydrogen phosphate, sodium phosphate, potassium phosphate, sodium carbonate, potassium carbonate, and combinations thereof.

Some embodiments provide that the electrolyte 120 may include an acid comprising citric acid, glutaric acid, boric acid, acetic acid, propionic acid, phosphoric acid, phosphorous acid, hydrochloric acid, sulfuric acid, amino acids, sulfonic acids, and combinations thereof.

The electrolyte 120 may be configured according to some embodiments to include a base comprising sodium hydroxide, potassium hydroxide, calcium hydroxide, lithium hydroxide, and combinations thereof.

In an embodiment, the liquid used to hydrate the hydrogel 115 may comprise one or more forms of water. For example, the water may consist of one or more of the following: ground water, industrial water effluent, drinking water, rain water, brackish water, surface water, mineral water, salt water, substantially fresh water, distilled water, deionized water, and combinations thereof. In some embodiments, the hydrogel 115 may be hydrated with liquids including, without limitation, perspiration, blood, milk, and organic liquids (e.g., solvents).

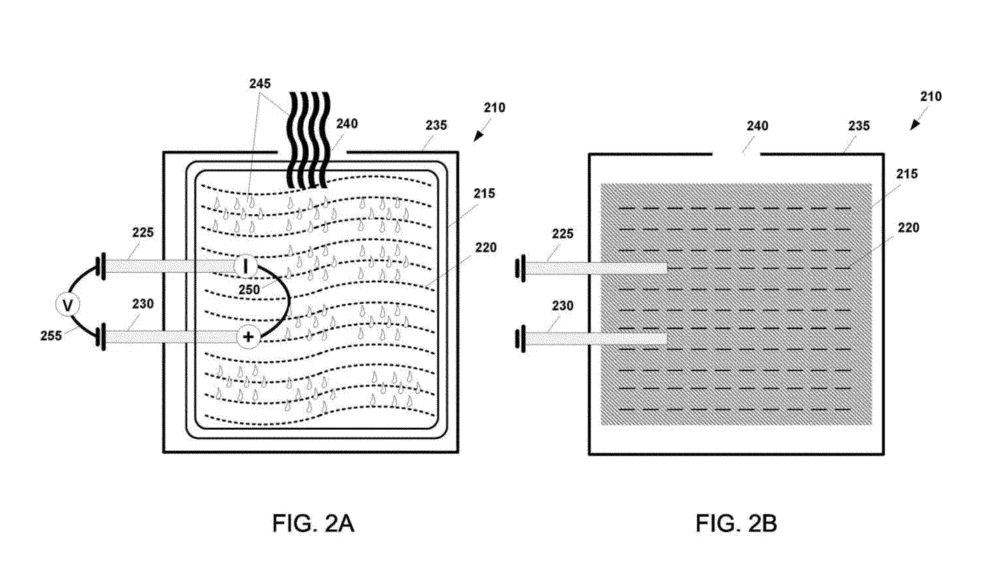

FIG. 2A and FIG. 2B depict an illustrative liquid-activated battery comprising a hydrogel in a hydrated state and a hydrogel in a dehydrated stat, respectively, according to some embodiments. In FIG. 2A, a battery 210 comprises a battery case 235 enveloping a hydrogel 215 permeated with electrolyte 220. A cathode 225 and an anode 230 are in contact with the hydrogel 215 and the electrolyte 220 permeating the hydrogel 215. The battery case 235 has an opening 240 that allows water 245 to enter the battery and hydrate the hydrogel 215 such that the hydrogel enters a hydrated state. For example, water may enter the battery case 235 when the battery 210 is submerged underwater or otherwise exposed to water. In the hydrate state, the hydrogel 215 is permeated with water such that the hydrogel 215 supports ionic communication 250 between the cathode 225 and the anode 230 through the electrolyte. For example, in the hydrated state, the hydrogel 215 and/or electrolyte 220 is fluid enough to allow for the movement of ions necessary for the ionic communication 250. In some embodiment, liquid flow is permitted into and out of the hydrogel. When the hydrogel is being hydrated, the water inflow is greater than the outflow. When the hydrogel is being dehydrated, the water outflow is greater than the inflow. In some instances, equilibrium may be achieved. In such instances, the hydrogel may be effectively hydrated or effectively dehydrated, depending upon the amount of liquid in the hydrogel at equilibrium.

The exact nature of the ionic communication 250 depends on, among other things, the materials used for the cathode 225, the anode 230, and the electrolyte 220. For example, the liquid-activated battery 210 may comprise a copper cathode 225, a zinc anode 230, and an acid, such as sulfuric acid, as the electrolyte 220, and the ionic communication 250 may comprise at least positive zinc ions. Once the hydrogel 215 is in the hydrated state, ionic communication 250 may occur according to principles of battery operation known to those having ordinary skill in the art.

The ionic communication 250 may operate to generate a voltage 255, for example, if the liquid-activated battery 210 is connected as a power source to an electronic device. Illustrative electronic devices include, without limitation, a sensor, an actuator, a processor, a switch, a light source, an alarm, a receiver, a transceiver, a transponder, a radio-frequency identification device, contact lenses associated with power displays and/or circuits, and combinations thereof. In an embodiment, the voltage 255 generated by the liquid-activated battery 210 when the hydrogel is in the hydrated state is at least about 0.9 V. In another embodiment the voltage 255 may be from about 0.9 V to about 3.0 V. The voltage 255 may be generated according to principles of battery operation known to those having ordinary skill in the art.

In some embodiments, the total energy capacity associated with the liquid-activated battery 210 may be related to the amount of the material that makes up the anode 236. The cathode 225 may not be consumed during the chemical reactions that generate the ionic communication 250; however, the larger the cathode 225, the higher the current it may handle. According to some embodiments, a plurality liquid-activated batteries may be used to power or partially power an electronic device. Some embodiments provide that at least a portion of the plurality of liquid-activated batteries may be connected in series, parallel, both series and parallel, and combinations thereof. In a non-limiting example, a first portion of the plurality of liquid-activated batteries may be connected in series and a second portion of the plurality of liquid-activated batteries may be connected in parallel in another non-limiting example, the first portion may be connected to the second portion. In an embodiment, multiple parallel anode 230—cathode 225 connections may increase the current. In another embodiment, multiple serial anode 230—cathode 225 connections may increase the voltage 255 generated by the liquid-activated battery 210.

Referring to FIG. 2B, therein is provided an example of a liquid-activated battery in a dehydrated state. In FIG. 2B, the hydrogel 215 is not saturated with water and is in a dehydrated state. For example, the water may have been drained from the battery case 235 through the opening 240 and/or the water may have evaporated from the battery case 235 and the water vapor escaped through the opening 240. The nature of and the time required for water removal from the battery case 235 may depend on various factors, including the components and thickness of the hydrogel 215, the electrolyte 220, the structure of the battery case 235 and the number of openings 240, and the level of saturation of the hydrogel 215. When the hydrogel 215 is in the dehydrated state, ionic communication does not occur between the anode 230 and the cathode 225. As such, the liquid-activated battery 210 does not generate a voltage. In the dehydrated state, the hydrogel 215 and/or electrolyte 220 is dry (e.g., free or substantially free of liquid) and is not fluid enough to allow for the movement of ions necessary for the ionic communication 250.

As demonstrated by the example embodiments of FIG. 2A and FIG. 2B, the liquid-activated battery may alternate between an operative state (e.g., the hydrated state) and a dormant state (e.g., the dehydrated state). Movement between the hydrated and dehydrated states may be a function of whether the hydrogel is in contact with an effective amount of water. The time required to move between the hydrated state and the dehydrated state, and vice versa, may depend on various factors, including the structure and materials of the liquid-activated battery components. For example, certain hydrogels associated with certain hydrophilic polymers may require a different amount of liquid and/or a different length of exposure to liquid to enter the hydrated state. In addition, physical dimensions, such as the size and thickness of a hydrogel, may be a factor. In another example, each electrolyte material may support ionic communication at a different level of hydrogel saturation. One difference between the hydrated state and the dehydrated state of a hydrogel is that ionic communication between the anode and the cathode may occur in the hydrated state and is prevented in the dehydrated state.

In an embodiment, the time to move between the hydrated state and the dehydrated state, and vice versa, may take about 1 second to about 5 minutes. In another embodiment, the time required to move between stales may take about 1 second to about 30 seconds. In yet another embodiment, the time required to move between states may take about 20 seconds to about 1 minute. In a further embodiment, the time required to move between states may take about 1 minute to about 3 minutes. In an embodiment, the hydrogel may comprise pHEMA having a thickness of about 1 mm, wherein the time to move between states may take about 1 minute to about 3 minutes.

Although only one liquid-activated hydrogel battery 210 is depicted in FIG. 2A and 2B, embodiments are not so limited, as a plurality of batteries is also contemplated herein. In an embodiment, the plurality of batteries may comprise a plurality of liquid-activated hydrogel batteries. In another embodiment, the plurality of batteries may comprise one or more liquid-activated hydrogel batteries and one or more traditional batteries.

The plurality of batteries may be connected in series, in parallel, and in combinations thereof. An example provides that two or more of the plurality of batteries may be connected in series, for instance, to increase the available voltage produced by the plurality batteries. In another example, two or more of the plurality of batteries may be connected in parallel for instance, to increase the available current provided by the plurality batteries.

Some embodiments provide that one or more liquid-activated batteries may be connected to one or more traditional batteries in series, parallel, or combinations thereof. In an embodiment, an active liquid-activated hydrogel battery may operate to close a circuit connected to a traditional battery acting as a power supply for one or more electronic devices. In this manner, the liquid-activated hydrogel battery may operate similar to a liquid-activated on/off switch, allowing the traditional (and potentially higher voltage) battery to operate when the liquid-activated hydrogel battery is sufficiently hydrated.

In an embodiment, the liquid-activated battery may operate in wet or substantially wet environments. The liquid-activated battery is especially well-suited for applications that cycle from wet to dry. The liquid-activated battery may form a battery circuit and provide power to a battery-powered electronic device responsive to exposure to water in the wet or substantially wet environment. As such, a liquid-activated battery configured according to some embodiments may operate as a power supply for an electronic device developed to operate in a wet or substantially wet environment. For example, certain wetsuits used for underwater operations (e.g., SCUBA diving) may have embedded sensors configured to detect certain compounds, such as phenol contaminants. A liquid-activated battery may power such a sensor, forming a battery circuit when the wearer of the wetsuit goes underwater and exposes the battery to water. When the wetsuit is removed from the water, the water may leave the battery and the hydrogel may enter the dehydrated state. In this manner, the battery may be activated when needed during underwater activity and may become dormant when not needed. Such a configuration may operate to, among other functions, conserve resources and energy, and to increase the life of the liquid-activated battery and the electronic devices powered by the liquid-activated battery. Additional examples include electronic devices embedded in clothing exposed to perspiration and radio-frequency identification (RFID) devices used to track underwater assets, such as fish is an aquarium and equipment used by offshore drilling companies.

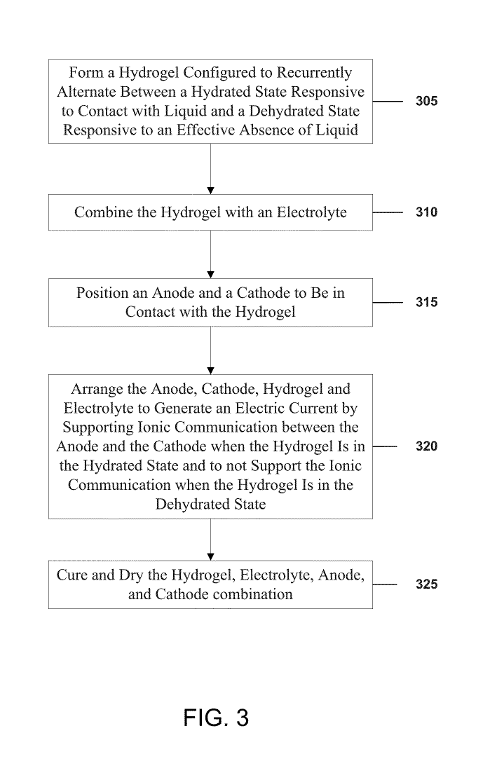

FIG. 3 depicts a flow diagram for an illustrative method of manufacturing a liquid-activated battery according to an embodiment. A hydrogel may be formed 395 for placement in the liquid-activated battery. The hydrogel may be configured to recurrently alternate between a hydrated state responsive to contact with liquid and a dehydrated state responsive to an effective absence of liquid. The hydrogel may be formed 305 to conform to the size and shape required for the battery and to serve as a substrate for a chemical reaction adequate to generate sufficient voltage or current ranges. The formed 305 hydrogel may move between the hydrated state and the dehydrated state repeatedly, being dried out and then saturated again as required.

In an embodiment, the hydrogel may comprise one or more hydrophilic polymers. The hydrophilic polymers may be generated from one or more hydrophilic monomers. An illustrative hydrophilic monomer is hydroxyethyl methacrylate (HEMA). The hydrogel may additionally be mixed with one or more polymerization initiators, for example, to initiate polymerization of HEMA monomers into polyhydroxyethyl methacrylate (pHEMA) polymers. An illustrative polymerization initiator includes 2,2′-azobis-2-methyl-propanimidamide, dihydrochloride (AAPH).

The hydrogel may be combined 310 with an electrolyte. The electrolyte may permeate the hydrogel or may be confined to one or more areas of the hydrogel. The electrolyte may be comprised of various forms, including gels, pastes, solids, and liquids. When the hydrogel is in the hydrated phase, the electrolyte may be in solution, in an aqueous phase, a gel-like phase, or some combination thereof. When the hydrogel is in the dehydrated phase, the electrolyte may be in a solid of semi-solid phase, such as being a single solid mass or collection of solid particles. For example, if the electrolyte comprises a salt, the electrolyte may comprise an aqueous sail solution when the hydrogel is in the hydrated state and may comprise solid or substantially solid salt particles when the hydrogel is in the dehydrated state. The formed 305 hydrogel combined 310 with the electrolyte may be positioned or poured (depending on the state of the combination) into a mold. For example, the mold may operate to contain the hydrogel-electrolyte combination during the formation process and/or the mold may operate to conform the hydrogel to a particular size or shape required for the liquid-activated battery.

In an embodiment electrolytes used in the liquid-activated battery may be arranged as part of the hydrogel polymer. For example, using an electrolyte as part of the hydrogel polymer may operate to prevent migration into the liquid contacting the hydrogel (e.g., to prevent the electrolyte from seeping out into the surrounding water when the liquid-activated battery is used in an underwater environment). According, to some embodiments, the hydrogel may comprise a polyelectrolyte, which include polymers comprising a repeating unit bearing an electrolyte group. Non-limiting examples include polyacrylic acid/salt, polymethacrylic acid/salt, polystyrene sulphonic acid/salt, ionic polypeptides, ionic polysaccharides.

An anode and a cathode may be positioned 315 in contact with the hydrogel. For example, the anode and the Cathode may be arranged within the hydrogel such that they are not in direct contact with each other. The anode and the cathode may contact the hydrogel such that they are also in contact with the electrolyte that is combined 310 with the hydrogel. Although one hydrogel, electrolyte, anode, and cathode have been used is certain examples herein, embodiments are not so limited, as any number and combination of hydrogels, electrolytes, anodes, and cathodes are contemplated herein.

The anode, cathode, hydrogel, and electrolyte may be arranged 320 to form a battery circuit. The battery circuit may be configured to generate an electric current responsive to ionic communication between the anode and the cathode via the electrolyte. The anode and the cathode may be arranged 320 to contact the hydrogel such that the ionic communication via the electrolyte is supported by the hydrogel is the hydrated state and is not supported by the hydrogel in the dehydrated state. As such, the anode and the cathode may be located in proximity to each other to facilitate the flow of ions therebetween. In addition, the anode and the cathode may be in sufficient contact with the hydrogel such that the electrolyte may promote the flow of ions between the anode and the cathode. The anode, cathode, hydrogel, and electrolyte may be arranged 320 such that the electric current generated due to the ionic communication may be used to power an electronic device connected to the battery circuit.

The hydrogel, electrolyte, anode, and cathode battery circuit combination may be cured and dried 325. For example, an oven may be used to cure the battery circuit. An illustrative oven may be a substantially oxygen tree oven, wherein the battery circuit is cured at a specific temperature for a specific duration, for instance, about 50° C. for about 3 hours. Another oven may be used to dry the battery circuit. A non-restrictive example provides that the drying oven may be a forced air oven, wherein the cared battery circuit may be dried at about 100° C. for a period of time until dry (e.g., about 3 hours).

In an embodiment, one or more salts may be added to the hydrogel, for example, during formation 305, to reduce corrosion of the anode. Use of a corrosion reducing salt and the type thereof may depend on the type of anode. For example, the salt zinc chloride may be used for a zinc anode.

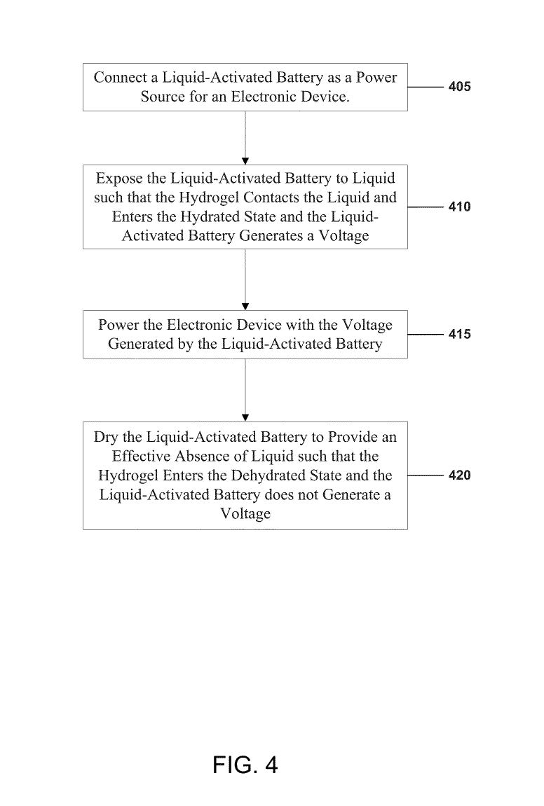

FIG. 4 depicts a flow diagram for an illustrative method of providing battery power to an electronic device according to an embodiment. A liquid-activated battery configured according to some embodiments provided herein may be connected 405 as a power source for a battery-powered electronic device. For example, an anode and a cathode of the liquid-activated battery may be connected 405 to an electronic or digital circuit of the electronic device, such as a very-large-scale integration (VLSI) circuit. Illustrative and non-restrictive electronic devices include a sensor, an actuator, a processor, a switch, a light source, an alarm, a receiver, a transceiver, a transponder, a radio-frequency identification device, and combinations thereof.

The liquid-activated battery may be exposed 410 to liquid. For example, the liquid-activated battery may consist of a case enclosing the liquid-activated battery components, such as the hydrogel, the electrolyte, the anode, and the cathode. The case may have one or more openings that allow liquid to enter and exit the liquid-activated battery. Liquid entering the case may contact 410 the hydrogel such that the hydrogel enters the hydrated state. In the hydrated state, the hydrogel may support ionic communication between the anode and the cathode via the electrolyte. Ionic communication may occur because, among other things, the electrolyte is in a liquid, substantially liquid, or gel-like state that is fluid enough to allow for the movement of ions between the anode and the cathode. The ionic communication, may operate to generate a voltage 410. In an embodiment, the voltage may be at least 0.9 V. In another embodiment, the voltage may be about 0.9 V to about 3.0 V.

The voltage generated by the liquid-activated battery may power 415 the electronic device. Use electronic device may operate and perform one or more functions powered by the voltage. For example, an RFID electronic device may use the power provided by the liquid-activated battery to transmit location information associated with the RFID electronic device, for example, used to tag underwater equipment.

An effective absence of liquid will dry 420 the liquid-activated battery such that the hydrogel enters the dehydrated state. When the hydrogel is in the dehydrated state, the hydrogel does not support ionic communication between the anode and the cathode and the liquid-activated battery does not generate a voltage. Ionic communication is not supported because, among other things, the electrolyte is free or substantially free of liquid and, therefore, it is not fluid enough to allow for the movement of ions between an anode and a cathode. In this manner, the liquid-activated battery may deactivate and enter a dormant state. A liquid-activated battery configured according to some embodiments may continuously alternate between an active state (e.g., hydrogel is hydrated and the battery is generating a voltage) and a dominant state (e.g., hydrogel is dehydrated and the battery is not generating a voltage) by exposing the liquid-activated battery to liquid and by allowing the liquid-activated battery to dry (e.g., by draining the liquid-activated battery and/or allowing the liquid to evaporate).

### EXAMPLES

### Example 1

### Battery-Powered Temperature Sensor

A liquid-activated battery will be manufactured as a power source for a battery-powered temperature sensor. The liquid-activated battery will include a case configured to hold the battery components and to fit into the battery compartment of the temperature sensor. The case includes openings to allow for the entry and exit of water into the liquid-activated battery. The battery components will include at least a hydrogel, an electrolyte, a cathode, and an anode. The hydrogel and electrolyte will be combined by mixing about 100 g of the monomer hydroxyethyl methacrylate (HEMA), about 0.5 g of polymerization initiator 2,2′azobis-2-propanimidamide, dihydrochloride (AAPH), and about 5 g of the electrolyte ammonium chloride dissolved in about 20 mL of water. The hydrogel will consist of polyhydroxyethyl methacrylate (pHEMA) permeated with ammonium chloride electrolyte.

The polyhydroxyethyl methacrylate (pHEMA) and ammonium chloride mixture will be poured into a mold having dimensions commensurate with the case. Use dimensions will be about 2 cm×1 cm×0.2 cm. A thin piece of copper having dimensions of about 1.5 cm×0.5 cm×0.01 cm will be inserted into the mold as the cathode. A thin piece of zinc having dimensions of about 1.5 cm×0.5 cm×0.03 cm will be inserted into the mold as the anode. The anode and the cathode will not be in contact with each other. The anode and the cathode will be inserted into the mold such that they are in contact with the electrolyte. Portions of the anode and the cathode will not be inserted into the mold and will be exposed outside of the case as electrode leads. The portions of the anode and the cathode inserted into the mold will be entirely surrounded by the hydrogel and electrolyte.

The mold will be heated in a substantially oxygen free oven at about 50° C. for about 3 hours. The mold will be dried by heating the mold in a forced air oven at about 100° C. until dry (e.g., about 1 hour). The contents of the mold will be inserted into the case to form the liquid-activated battery.

The liquid-activated battery will be inserted into the battery compartment of the temperature sensor such that the electrode leads contact the circuitry of the temperature sensor to complete a power circuit for the temperature sensor. The temperature sensor will be submerged underwater and water will enter the battery case. In about 1 minute, the water will saturate the hydrogel and the hydrogel will enter the hydrated state. Ionic communication will occur between the anode and the cathode and the liquid-activated battery will generate a voltage of about 0.9 V to power the temperature sensor. The temperature sensor will measure the temperature of the crater and provide a temperature reading on a readout display panel.

The temperature sensor will be removed from the water and the water will drain from the battery case through the openings. Water will additionally evaporate from the hydrogel and the resultant wale vapor will exit the liquid-activated battery through the openings. In about 10 minutes, the hydrogel will enter the dehydrated state and the liquid-activated battery will be deactivated.

### EXAMPLE 2

### Embedded Water Contaminant Sensor

A liquid-activated battery will be manufactured as a power source for a water contaminant sensor configured to be embedded in a wetsuit, The liquid-activated battery will include hydrogel electrolyte, anode, and cathode battery components arranged within a ease. The hydrogel will be polyacrylamide-based and will be combined with a sodium carbonate electrolyte. The hydrogel will support 3 anodes consisting of aluminum and 3 cathodes consisting of graphite configured as parallel connections. The battery components will be eared and dried and arranged within the case. The liquid-activated battery will be placed in the battery compartment of the water contaminant sensor having circuitry to receive the 3 anodes and the 3 cathodes. The writer contaminant sensor will be embedded in the sleeve of a wetsuit.

The liquid-activated battery will be exposed to salt-water when the wearer of the wetsuit enters a salt-water body of water, submerging the embedded water contaminant sensor. The salt-water will enter the liquid-activated battery through an opening in the case and will saturate the hydrogel such that the hydrogel enters the hydrated state within about 2 minutes after contact with the salt-water. The hydrated hydrogel will support ionic communication between the anodes and the cathodes. The ionic communication will generate a voltage of about 1.0 V to power the contaminant sensor (e.g., a phenol sensor) and a light-emitting diode (LED) display for displaying information regarding the contaminates (e.g., types and amounts of detected contaminants).

The wetsuit will be removed from the body of water and the liquid-activated battery will dry within about 1 hour. The hydrogel will enter the dehydrated state and the liquid-activated battery will be de-activated, no longer supplying a voltage to the water contaminant sensor.

If to the above detailed description, reference is made to the accompanying drawings, which form a part hereof. In the drawings, similar symbols typically identity similar components, unless contest dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from, the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of coarse, vary. It is also to be understood that the terminology used herein is tor the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to he construed as an admission that the embodiments described in this disclosure are not entitled to antedate such disclosure by virtue of prior developments. As used in this document, the term “comprising” means “including, but not limited to.”

It will be understood by those within the art that, in general, terms used herein, and especially in the appended claims (e.g., bodies of the appended claims) are generally intended as “open terms (e.g. the term “including” should be interpreted as “including but not limited to,” the term having” should be interpreted as “having at least,” the term “includes” should be interpreted as “includes but is not limited to,” etc.). While various compositions, methods, and devices are described in terms, of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “as” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bam recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc). It will be further understood by those within the art that virtually any disjunctive word and/or phrase presenting two or more alternative terms, whether in the description, claims, or drawings, should he understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 13 cells refers to groups having 1, 2, or 3 cells. Similarly, a group having 15 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A liquid-activated battery comprising:
at least one hydrogel comprising at least one hydrophilic polymer and at least one electrolyte, the at least one hydrogel configured to recurrently alternate between a hydrated state responsive to contact with liquid and a dehydrated state responsive to an effective absence of liquid; and
at least one anode and at least one cathode in contact with the at least one hydrogel;
wherein ionic communication between the at least one anode and the at least one cathode via the at least one electrolyte is supported by the at least one hydrogel in the hydrated state and is not supported by the at least one hydrogel in the dehydrated state, the ionic communication generating an electric current for the battery.

2. The liquid-activated battery of claim 1, wherein the at least one hydrophilic polymer is polymethacrylate, polyacrylate, polymethacrylamide, polyacrylamide, polyvinyl alcohol, polyvinyl acetate, cellulose or modified cellulose, collagen or modified collagen, polysaccharide, modified polysaccharide, polynucleotide, polyelectrolyte, polyhydroxy ethyl methacrylate (pHEMA), and combinations thereof.

3. (canceled)

4. The liquid-activated battery of claim 1, wherein the at least one anode comprises an anode material selected from zinc, magnesium, aluminum, calcium, lithium, conducting polymers, iron, nickel, metal oxides, and combinations thereof.

5. The liquid-activated battery of claim 1, wherein the at least one cathode comprises a cathode material selected from copper, carbon, silver, metal oxides, conducting polymers, carbon, carbon nanotubes, graphite, graphene, and combinations thereof.

6. The liquid-activated battery of claim 1, wherein the at least one electrolyte is selected from a salt, an acid, and a base.

7. The liquid-activated battery of claim 6, wherein the salt is selected from ammonium sulfate, ammonium hydrogen sulfate, ammonium nitrate, ammonium phosphate, ammonium hydrogen phosphate, ammonium dihydrogen phosphate, ammonium chloride, sodium hydrogen sulfate, potassium hydrogen sulfate, sodium dihydrogen phosphate, potassium dihydrogen phosphate, sodium phosphate, potassium phosphate, sodium carbonate, potassium carbonate, and combinations thereof.

8. The liquid-activated battery of claim 6, wherein the acid is selected from citric acid, glutaric acid, lactic acid, boric acid, acetic acid, propionic acid, phosphoric acid, phosphorous acid, hydrochloric acid, sulfuric acid, amino acids, sulfonic acids, and combinations thereof.

9. The liquid-activated battery of claim 6, wherein the base is selected from sodium hydroxide, potassium hydroxide, calcium hydroxide, lithium hydroxide, and combinations thereof.

10. (canceled)

11. The liquid-activated battery of claim 1, wherein the liquid is water selected from ground water, industrial water effluent, drinking water, rain water, brackish water, surface water, mineral water, salt water, substantially fresh water, distilled water, deionized water, and combinations thereof.

12. (canceled)

13. The liquid-activated battery of claim 1, wherein the electric current generated by the ionic communication between the at least one anode and the at least one cathode yields a battery voltage of about 0.9 V to about 3.0 V.

14.-16. (canceled)

17. An electronic device comprising:
a power supply, wherein the power supply comprises a liquid-activated battery comprising: at least one hydrogel comprising at least one hydrophilic polymer and at least one electrolyte, the at least one hydrogel configured to recurrently alternate between a hydrated
state responsive to contact with liquid and a dehydrated state responsive to an effective absence of liquid, and
at least one anode and at least one cathode in contact with the at least one hydrogel, wherein ionic communication between the at least one anode and the at least one cathode via the at least one electrolyte is supported by the at least one hydrogel in the hydrated state and is not supported by the at least one hydrogel in the dehydrated state, the ionic communication generating an electric current for the battery.

18. The electronic device of claim 17, wherein the electronic device is selected from a sensor, an actuator, a processor, a switch, a light source, an alarm, a receiver, a transceiver, a transponder, a radiofrequency identification device, and combinations thereof.

19.-20. (canceled)

21. A method of preparing a liquid-activated battery, the method comprising:
providing at least one hydrogel comprising at least one hydrophilic polymer and at least one electrolyte, the at least one hydrogel configured to recurrently alternate between a hydrated state responsive to contact with liquid and a dehydrated state responsive to an effective absence of liquid; and
arranging at least one anode and at least one cathode to be in contact with the at least one hydrogel to prepare the battery, wherein ionic communication between the at least one anode and the at least one cathode via the at least one electrolyte is supported by the at least one hydrogel in the hydrated state and is not supported by the at least one hydrogel in the dehydrated state, the ionic communication generating an electric current for the battery.

22. The method of claim 21, wherein providing the at least one hydrogel comprises combining the at least one hydrophilic polymer, at least one polymerization initiator, and the at least one electrolyte in a mold;
wherein arranging the at least one anode and the at least one cathode to be in contact with the at least one hydrogel comprises inserting the at least one anode and the at least one cathode into the mold in contact with the at least one hydrogel such that the at least one anode does not contact the at least one cathode.

23.-25. (canceled)

26. The method of claim 22, wherein the at least one polymerization initiator comprises 2,2′-azobis-2-methyl-propanimidamide, dihydrochloride (AAPH).

27. The method of claim 21, wherein the at least one hydrogel comprises at least one hydrophilic polymer selected from polymethacrylate, polyacrylate, polymethacrylamide, polyacrylamide, polyvinyl alcohol, polyvinyl acetate, cellulose or modified cellulose, collagen or modified collagen, polysaccharide or modified polysaccharide, polynucleotide, polyelectrolyte, polyhydroxy ethyl methacrylate (pHEMA), and combinations thereof.

28. (canceled)

29. The method of claim 21, wherein the at least one anode comprises an anode material selected from zinc, magnesium, aluminum, calcium, lithium, conducting polymers, iron, nickel, metal oxides, and combinations thereof.

30. The method of claim 21, wherein the at least one cathode comprises a cathode material selected from copper, carbon, silver, metal oxides, conducting polymers, carbon, carbon nanotubes, graphite, graphene, and combinations thereof.

31. The method of claim 21, wherein the at least one electrolyte is selected from a salt, an acid, or a base.

32. The method of claim 31, wherein the salt is selected from ammonium sulfate, ammonium hydrogen sulfate, ammonium nitrate, ammonium phosphate, ammonium hydrogen phosphate, ammonium dihydrogen phosphate, ammonium chloride, sodium hydrogen sulfate, potassium hydrogen sulfate, sodium dihydrogen phosphate, potassium dihydrogen phosphate, sodium phosphate, potassium phosphate, sodium carbonate, potassium carbonate, and combinations thereof.

33. The method of claim 31, wherein the acid is selected from citric acid, glutaric acid, lactic acid, boric acid, acetic acid, propionic acid, phosphoric acid, phosphorous acid, hydrochloric acid, sulfuric acid, amino acids, sulfonic acids, and combinations thereof.

34. The method of claim 31, wherein the base is selected from sodium hydroxide, potassium hydroxide, calcium hydroxide, lithium hydroxide, and combinations thereof.

35.-36. (canceled)

37. The method of claim 21, wherein the liquid is water selected from ground water, industrial water effluent, drinking water, rain water, brackish water, surface water, mineral water, salt water, substantially fresh water, distilled water, deionized water, and combinations thereof.

38. (canceled)

39. The method of claim 21, wherein the electric current generated by the ionic communication between the at least one anode and the at least one cathode yields a battery voltage of about 0.9 V to about 3.0 V.

40. The method of claim 21, wherein the electronic device is selected from a sensor, an actuator, a processor, a switch, a light source, an alarm, a receiver, a transceiver, a transponder, a radiofrequency identification device, and combinations thereof.

41. The method of claim 21, wherein the liquid-activated battery comprises a power supply of an electronic device configured to operate in a wet environment.

42.-67. (canceled)
